(19) United States
(12) Patent Application Publication
(10) Pub. No.: US 2018/0219505 A1
(43) Pub. Date: Aug. 2, 2018

(54) Phase Balance Efficiency System to Improve Motor Efficiency and Power Quality

(71) Applicant: Robert Temple Emmet, Galesville, MD (US)

(72) Inventor: Robert Temple Emmet, Galesville, MD (US)

(21) Appl. No.: 15/676,706

(22) Filed: Aug. 14, 2017

Related U.S. Application Data
(63) Continuation of application No. 62/499,604, filed on Jan. 31, 2017.

(51) Int. Cl. H02P 23/26

(52) U.S. Cl. CPC H02P 23/26

(57) ABSTRACT

Triangular capacitor arrays have been used for many years to match inductive impedance and to correct power factor in 3-phase circuits. Recent studies of the electrical properties of the phase balance capacitor array, including harmonics retention, have revealed new methods of reducing system harmonic interference which combine to significantly increase induction motor efficiency. For example, in inductive circuits, by varying the capacitance of these arrays using harmonic sensors and feedback loops, a method is shown to construct harmonic filters within the motor-PB array complex. If these harmonics, which are necessary for motor action, are not dissipated, then they don't need to be regenerated, thus saving power and improving the motor efficiency by 3%-5%. In addition, these symmetric capacitor arrays can be used to balance the magnitudes of the single-phase voltage and amperage signals, moving them closer to the mean values over the 3 phases. This phase balancing method attenuates spikes and provides ride-through capacity to protect loads from thermal damage and improves circuit stability. Design and manufacturing methods of these phase balance arrays for WYE and Delta circuits are discussed.

### CROSS-REFERENCE TO RELATED APPLICATIONS

This Utility patent application is a continuation of Provisional Patent Application No. 62/499,604 filed on Jan. 31, 2017 by Robert Temple Emmet of 4883 Church Lane, Galesville, Md., 20765. 443 941-6242, Capt.Emmet@gmail.com.

Although many elements of the Phase Balance Efficiency System have been known and used for years, the electrical mechanisms of interaction between the 3-phase capacitor array and the induction motor were not understood until the recent work by the inventor. This work has enabled the development of new methods of continuously tuning the phase balance system by using feedback loops to achieve improved levels of efficiency and power quality. In this specification the term network will refer to the three phase power supply, distribution system and all associated circuits connected to the motor. The term system will refer to the phase balance efficiency system comprising the capacitor array, harmonics sensor and feedback loop.

### BACKGROUND OF THE INVENTION

Since 1900 when three-phase electrical power began to expand into our modern power distribution network, the power quality at any point has been dependent on the system remaining continuous and balanced. The power is generated by precision machinery and then distributed as three separate phases to the end user. Seventy percent of the generated power is used by 3-phase induction motors, 20% by industrial lighting and the remnant is transformed down to 120/240 V split-phase for residential uses. As these separate power phases travel from the generation sites, many factors affect the power quality and system balance. Transient faults usually occur on only one phase at a time, and unbalanced use of individual phases will also cause voltage imbalance. Restoring power quality for the end-user requires a means to restore the precise phase balance (PB) between the individual power phases. Balanced 3-phase power is a design requirement for all end-user 3-phase equipment. The present invention, The Phase Balance Efficiency System provides a method of filtering the harmonics to achieve greater motor efficiency and of balancing the phases to restore Power Quality using a passive, self-healing, robust device, the PB Unit.

It would be desirable to have such a PB device that would balance phase voltages and amperages in a 3-phase power system, thereby attenuating damaging single-phase spikes by sharing their power between the rebalanced phases. It would also be desirable to have such a device which sets up harmonic RCL filters with the moor field coils and continually tunes these harmonic filters to retain the motor amperage harmonics. These harmonics therefore are not dissipated as interference and heat in the distribution system and they do not require regeneration to support motor action. Saving this harmonic power which comprises 3% to 6% of the fundamental power and using it for motor action, reduces the KW demand of the motor by 3% to 6%. Furthermore, it would also be desirable to have a device that lowers the operating temperature of the motor(s) and reduces the rate of thermal damage to the motor windings. Still further, it would be desirable to have a device which could sense changes in the motor operation and production of amperage harmonics and to be continually tuned to minimize production of said harmonics. Therefore, there currently exists a need in the electrical power industry for a device and associated method that improves power quality, network dependability and efficiency of motors thus reducing the costs of operation and maintenance.

Nicola Tesla 1888 (1) arranged field coils between the phases of a 3-phase alternating current electrical system to produce his famous rotating magnetic field within the interior space. In the patent (1), as discussed in Steinmetz 1897 (2), Tesla reasoned that three alternating current magnetic fields, at 120 degree angles in space and differing in time phase by 120 degrees, would combine to produce a rotating magnetic field, which in Tesla's model, repelled the rotating armature containing reverse magnetism from induced current therein and the Induction Motor was born.

In recent power quality research, Emmet and Ray 2002-4 (3,4) have extended Tesla's concept by analogy and have reasoned that if three equal capacitors were connected between the phase lines in the 3-phase AC electrical system, that a rotating electrical field would be produced within the interior space. This work has also shown that when motor-run paper capacitors are connected between phases, that the capacitor charge/discharge cycle lags behind the driving polarity of the AC electric field. This lag is electrical hysteresis which provides a balancing effect the single phase voltage and amperage signals bring them closer to the mean values over 3 phases. Although phase balancing is only one of the simultaneous electrical features characterizing the Capacitor-motor interaction, this term has been chosen for this invention which manages that interaction. Phase balancing has useful applications in industrial circuits.

### STATEMENT REGARDING FEDERALLY SPONSORED RESEARCH AND DEVELOPMENT

Not Applicable

### REFERENCE TO SEQUENCE LISTING

Not Applicable

### BRIEF SUMMARY OF THE INVENTION

This invention pertains to the operating efficiency of three-phase induction motors, the stability of supporting electrical distribution systems and the quality of power to the end user in the distribution network. For many years attempts to improve motor efficiency have centered on matching the inductive impedance of the motor(s) with power factor correcting capacitors. By this method, efficiency improvements of 1% to 2% have been achieved by reducing system amperage and conductor heating losses. The present invention extends those results to 5% to 8% by developing a means of phase balancing through capacitor dielectric adsorption and through the retention of motor harmonic power by the maintenance of continually adjusted RCL tank cells which retain harmonic power in the PB array-motor complex while passing the fundamental frequency.

FIG. 4 is the key to the harmonic retention capacity of invention. The circuit in FIG. 4 was not obvious in past work with 3-phase power factor correction capacitors because the 3 inductors are from the motor field coils of a separate component. In the method claimed, the capacitor array is continually tuned using harmonics sensors with a feedback loop to minimize the harmonic power emanating from the motor-array complex. In this way the harmonic filters represented by the three RCL resonance cells in FIG. 4, act as low-pass filters, passing the 60 HZ fundamental power but retaining the harmonic power which is produced by the field coils and necessary for motor action, see Emmet and Ray (4). This retention of the harmonic power of the 3rd, 5th and 7th orders saves power because regeneration of the field-coil harmonics is not required. Also, the retention of the harmonics protects the surrounding distribution network from harmonic pollution as required by IEEE STD 519.

The present invention is a phase balance efficiency system, which is made up of the following components: 1) a triangular, symmetrical array of capacitors connected between the feeder phase lines to a three phase induction motor and 2) a means for tuning said capacitors to continually minimize the production of amperage harmonics produced by operation of said motor(s). These components are related in that the feedback control loop is connected to the capacitor array so as to continually tune the total capacitance of the array to improve motor efficiency by balancing the three feeder phases and minimizing the amperage total harmonic distortion, ITHD, emitting from the operating motor as a condition for motor action.

### BRIEF DESCRIPTION OF THE DRAWINGS

There are 4 drawings.

FIG. 1 shows a symmetrical capacitor array in the delta configuration where A, B and C represent the 3 electrical phases with the 3 equal capacitors being connected between the phases.

FIG. 2 shows the same symmetrical capacitor array with multiple capacitors, C1 through C9, connected between the said phases, A, B and C. FIG. 2 is the diagram for building the delta phase balance unit.

FIG. 3 shows a symmetrical capacitor array with multiple capacitors, C1 through C9 connected between said phases A, B, C and the neutral line N. FIG. 3 is the diagram for building the WYE phase balance unit.

FIG. 4 is a virtual circuit diagram combining the Capacitor Array with the induction motor and showing 3 rectangular RCL harmonic filters comprising the capacitors of FIG. 1 and the inductors of the nearby motor field coils. By selecting and continually adjusting the capacitor values by means of harmonics sensors and feedback loops, the RCL filters can be tuned to retain the energy of the 3rd, 5th, and 7th harmonics within the capacitor-motor complex while passing the energy of the fundamental frequency, 60 HZ.

### DETAILED DESCRIPTION OF THE INVENTION

The invention comprises a means of balancing the inductive impedance of the field coils of a 3-phase induction motor with the capacitive impedance of a triangular symmetric capacitor array in the old art. Additionally, this invention is used to balance the magnitudes of voltage and amperage harmonic signals, and is continually tuned to retain the harmonic power so that it is not lost as heat and interference in the local distribution system. By balancing the phases and retaining the harmonic power, said capacitor array improves the motor efficiency by up to 10%. In the prior power factor correction art these harmonics retention features were not available and a network efficiency improvement of only 1% to 2% was achieved. The phase balance efficiency system performs multiple useful power quality improvements simultaneously.

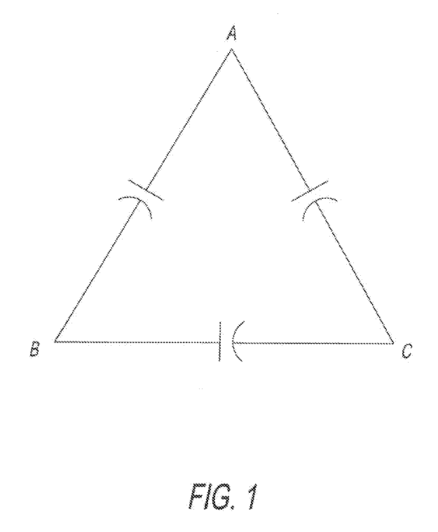

The symmetrical capacitor array is shown in FIG. 1 in delta Δ configuration, where A, B and C represent the 3 phases with equal capacitors connected between the phases. These capacitors are paper capacitors of equal strength within +/−5%. These paper capacitors are formed by rolling alternating layers of aluminum foil and oil-saturated paper as the dielectric. Alternate layers of foil separated by the paper dielectric are encapsulated in aluminum containers and are connected to the capacitor terminals. Each capacitor is filled with oil to exclude air and moisture. Paper capacitors are often used in power factor correction and motor power applications. The PB Unit capacitors are connected between the phases in 60 Hertz, 3-phase power systems. The electric field difference oscillation between the phases, although not sinusoidal, is 60 Hertz. The charge-discharge cycling of these capacitors required by the AC network exhibits electrical hystersis or lag in the capacitor dielectric.

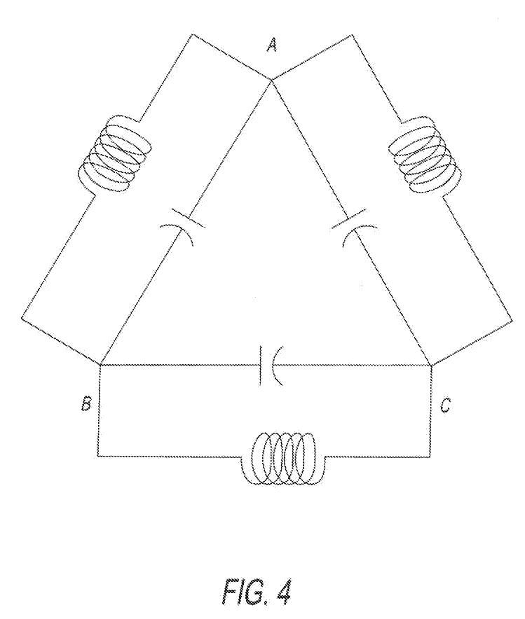

Modern Literature discusses the charging dynamics of the dielectric-electrode interface within the Electric Double-Layer Capacitor, see R. Burt et al 2014 (6). This has led to significant research efforts in computational simulation and modeling, aimed at developing new theories, or improving the existing ones to help interpret experimental results. Three phase SPICE Modeling of the motor-capacitor complex has shown that the virtual circuit represented in FIG. 4 predicts the measured retention of harmonic power within 10%. This modeling supports the structure and control of the phase balance efficiency system.

Phase Balancing is defined as the tendency, when a capacitor is connected between phases, for the magnitude of the voltage and the amperage signals to become closer to the mean values over the 3 phases. The physical mechanism for causing this phase balance is the electrical hysteresis lag which is termed dielectric adsorption and discussed by Williams (7). In each capacitor, the 60 Hz voltage signals cause a 60 Hz reversal of polarity within the Helmholtz layer and in the adjacent diffuse layers of the dielectric. During the rapid AC polarity oscillations, there is always an electrical hysteresis lag due to the Van der Waals stretching and rotating molecules within the dielectric layer which lags behind the driving electric field oscillation. This lag comprises a short-term memory of the immediately preceding polarity which is retained structurally in these dielectric layers. This memory provides a dynamic connection between the cycling electric phases in both voltage and amperage which is manifested in the phase balance phenomena detected in the 1999 Cutler-Hammer Data (5) which is described in paragraph 0022 below.

According to this Capacitor Dielectric Memory Theory, the phase balance phenomenon should increase with increasing frequency. Dielectric adsorption, which supports electrical hysteresis in capacitors, is the mechanism of van der Waals phase balancing and is further discussed by Tim Williams (7).

The means for tuning the capacitors comprise a sensor for amperage harmonic distortion or a related property to be placed on the line side of the parallel junction between the capacitor array and the motor feeder phase lines. This sensor is connected to a feedback mechanism that either varies the number of modular capacitor arrays connected to the motor control panel or varies the individual capacitors within a variable PB capacitor array connected to the panel.

To illustrate the basic geometry of the capacitor array, the Trinity Circuit is shown in FIG. 1 where motor-run capacitors of equal size are connected between three points: A, B and C. Capacitor arrays for other than 3-phase power systems would comply with those differing symmetries. The discussion will hereafter use the 3-phase symmetry because of its widespread application. Because the electric field behavior within the basic Trinity Circuit is essential to understanding the phase balance properties of the invention, this circuit will be discussed both isolated from and connected to 3-phase power.

Properties of the isolated Trinity Circuit with no external connections are discussed first. The Trinity Circuit as shown in FIG. 1 can be constructed by connecting 3 equal capacitors in a Delta Δ Configuration. The individual capacitance can be measured with a digital multimeter DMM following the procedure by Fluke Corporation. An example of this isolated circuit, with each capacitor 100 μF, is shown by this circuit-construction exercise.
1. Connect Cap AB and leave Caps BC and AC open. Measure capacitance AB=100 μF.
2. Then connect Cap AB and Cap BC with Cap AC open, and measure capacitance AC=50 μF.

Note: Caps AB and BC are in series and by the series capacitance rule, AC=1/100+1/100=1/50 μF.
3. Connect Cap AC to complete the Trinity Circuit and measure capacitance AB=BC=AC=150 μF.

Note: Cap AC is in parallel with Cap AB and Cap BC, therefore capacitance AC=AB=CB=100 μF+50 μF=150 μF by the parallel rule and the three capacitors are in series and in parallel at the same time in the symmetrical Trinity Circuit. The capacitance values for the three measurements, AC, AB and CB agree within the precision of the measurement instrument.

The Trinity Circuit can be combined with a 3-phase power system by connecting A, B and C in FIG. 1 to the A, B and C electrical phases. The stability of the Trinity Circuit will be imparted to the connected 3-phase circuit when balance is obtained by matching impedance of a parallel-connected motor. The capacitors are connected between the phases and the charge/discharge cycle will be in response to the 60 cycle non-sinusoidal AC Δ voltage waveform. This charge/discharge cycle is a frequency-dependant rotating electric field which is analogous to Tesla's rotating magnetic field (1)(2). When the rotating magnetic and electric fields are matched in an induction motor-capacitor complex, as shown in FIG. 4, then that complex will have maximal efficiency and stability.

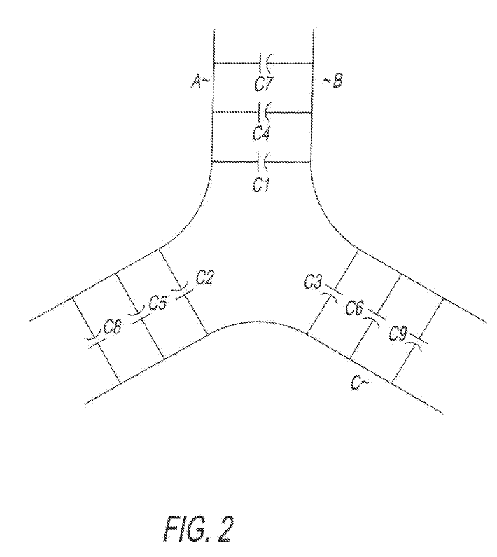

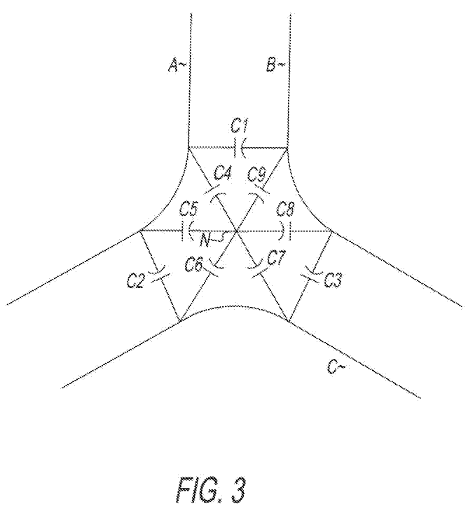

The present invention may also have one or more of the following: 1) instead of 3 capacitors, the phase balance (PB) capacitor array may comprise 3 branches of smaller capacitors connected between the phase lines feeding power to the three-phase motor in a parallel fashion according to FIGS. 2 and 3.

In FIG. 2, is shown a standard PB Delta Δ design, where A, B and C are the electrical phases and C1-C3 are 60 μF capacitors and C4-C9 are 35 μF capacitors connected between the three phase lines. The 60 μF and 35 μF capacitor were chosen because at the common user voltages of 220 and 480, the amperage in the phase leads of an energized PB Unit is 20 and 40 amps, respectively, which can be handled by 8 or 6 AWG multi-stranded copper wire. This is a limiting factor in the size of the modular PB Unit, because at higher unit capacitance, the leads would over-heat requiring heavier wire which is more expensive and more difficult to work.

FIG. 3 shows the Phase Balance Circuit used in WYE Power Circuits where A, B and C are the electrical phases and N is the neutral line. The values of the nine capacitors are similar with the DELTA PB Unit in FIG. 2. FIG. 4 will be discussed in paragraph 0006A and in paragraph 0040.

During construction of these PB Units, for three-phase use, once the proper symmetry has been achieved, the measured capacitance AB, BC and CA will agree exactly, within the precision of the measuring DMM, only when the circuit has perfected triangular symmetry. During PB Unit construction this exact agreement is a useful indication of correct circuit configuration before and without 3-phase testing or installation. The inherent stability of the PB Circuit is imparted to any connected circuit. Industrial power quality work in 3-phase systems has suggested several very useful applications.

The present invention, the Phase Balance (PB) Efficiency System, was suggested from the analysis of the Cutler Hammer Report and Data, 1999 (5) and application of these principles to industrial power quality problems Emmet and Ray 2002-4 (3,4). The present invention provides phase balance capacitor arrays (PB arrays) in modular PB Units which are dedicated to individual motors or to motor control panels. The PB arrays are continually tuned to correct the power factor as discussed above. The PB units are additionally effective because they can be tuned to minimize the motor-generated amperage harmonics which recovers 3 to 5 times the power recovered by power factor correction. The PB units are automatically controlled by a sensor feedback loop that monitors the ITHD, Amperage Total Harmonic Distortion, or related property in a power feeder phase line to minimize the power-wasting amperage ITHD harmonics generated by induction motor operation and instantly converts the recovered energy to motor action. This new harmonic controlling feature combines old and new art in one device or system because it controls power factor and converts recovered harmonic power into additional motor action to improve the motor efficiency.

In FIGS. 2 and 3, nine (9) capacitors have been chosen by packing considerations, however, PB arrays with 3, 6, 9, 12, or 15 capacitors would also work. Also, the Phase Balance Efficiency System can be used in any poly-phase power system by matching the symmetry. The final composition of the PB capacitor array is selected by packing considerations so as to minimize the volume of the array. The use of multiple, smaller capacitors maximizes the phase balance effect by increasing the area of the total Helmholtz double layer in the capacitor dielectric. The said capacitor array within a polymeric or steel case can also be encapsulated by closed-cell polyurethane foam for water-proof and physical shock-proof operation of the resultant PB unit. FIG. 4 will be further discussed in paragraphs 0006A and 0040.

The PB array with connected feedback loop can be connected by means of a three-phase thermomagnetic breaker to a motor control panel that controls multiple motors or connected directly to a single motor. When connected to a motor or panel, the PB array provides voltage balance control, voltage and amperage spike attenuation, and up-line power factor improvement. Where multiple modular PB arrays are connected to a particular panel, the feedback loop that senses the motor amperage total harmonic distortion, ITHD, can be used to switch on or off the individual modular PB arrays, to keep the combined PB array adjusted to the continually changing motor operation. If the motor(s) shut down, the feedback loop would disconnect all PB modules to match the impedances within the network.

This distributed control and protection is superior to customary service entrance power factor control capacitor banks because in variable harmonic environments the PB arrays eliminate the possibility of damaging RCL resonance between said capacitor banks and the large motors. 300 HP to 400 HP motors have been burned out by this RCL resonance in large food processing plants. The capacitor arrays in the PB Efficiency System are distributed throughout the plant power distribution network and such RCL resonance is not possible, Also, because many of the voltage and amperage imbalances are short-term transients, this automatic method for balancing the motor operation would capture and convert a greater amount of recovered harmonic power to additional motor action, thus reducing the power demand of the motor(s).

Similarly, the method associated with the present invention may also include one or more of the following steps: 1) the feedback loop sensors should monitor the ITHD (amperage total harmonic distortion) or related property in one of the motor feed phase lines at a point on the line side from the point of parallel connection of the capacitor array to the phase feed lines. 2) The feedback loop can be chosen to continually or intermittently sample the ITHD. 3) By including very few resistive elements in the capacitor array modules, heat production and energy loss are minimized and there is little heat buildup in the foam-encapsulated array. Also by using very robust components in the PB unit construction, PB unit maintenance is minimized and the useful PB unit lifetime is extended.

With respect to the choice of power parameter monitored to tune the PB Array to maximize efficiency, we have chosen ITHD because KW Efficiency is the objective. Feeder amperage or power factor were chosen in earlier power factor control devices because power factor improvement was the objective. However, any PB-sensitive power property can be used to tune the PB array in the present invention.

In its most complete form, the present invention device provides a complete system for controlling the voltage and amperage imbalance in the three feeder phases of an induction motor or motor control panel feeding multiple motors. If the device or multiple devices are connected through a branch distribution panel or motor control panel, then several motors can be balanced. The device comprises: 1) a triangular symmetrical capacitor array with small capacitors selected to maximize the total Helmholtz dielectric double layer, 2) a feedback loop to sense the ITHD (amperage total harmonic distortion) of the motor feeder phase line and 3) a means to connect the modular capacitor arrays to the motor control panel through a separate multiple breaker panel that switches the several PB arrays on/off to minimize the ITHD signal. The singular PB device can also contain variable capacitors which can be tuned to minimize the ITHD feedback signal from an individual motor. Such a PB device with variable capacitors can also be used to minimize the ITHD signal and thereby to maximize the recovered harmonic energy available for motor action.

It should be further noted that the triangular PB array can be enclosed in a polymeric or a steel enclosure. If the steel enclosure is used, a connected ground conductor is supplied with ampacity equal to that of the connecting phase lines. Capacitors chosen for the triangular arrays are aluminum oil-filled motor run capacitors of sufficient voltage rating to handle the expected applied voltage. It is noted here that other capacitors may be substituted in the PB Unit. The PB array connection leads are enclosed in flexible plastic conduit which attach mechanically to the PB unit enclosure and to the panel with waterproof seals. Wall mounting brackets for the PB Units are screw-attached galvanized steel tabs that can be removed if not required. If multiple PB Units are required to reduce the amperage harmonics on a particular inductive panel, then these modular PB units can be attached through a separate control panel containing several circuit breakers each leading to the individual PB Units. These breakers are automatically actuated by the ITHD sensing feedback loop to tune the combined PB array to balance the operating motors or to disconnect all the PB Units if all the motors are shut down. The power ITHD harmonic feedback sensors as required for each particular application should be selected with guidance from the manufacturing corporation or supplier. The most complete form of performing the method associated with the present invention consists of the following steps: 1) analyse the motor or inductive panel prior to connecting PB units, 2) Calculate the number of PB units necessary to reduce ITHD at maximum motor operating capacity, 3) design the PB unit mounting configuration with PB units connected directly to the panel, or for larger intermittent loads, to a separate multiple breaker control panel. 4) install the ITHD sensor on the line side of the panel feeder. Usually one sensor is sufficient attached to one of the phase lines. 5) connect the sensor with its power supply and to the automatic breakers which are designed to control the resultant PB array to minimize the ITHD of a single motor or of the several motors connected to the panel. If only one smaller motor is present, then it is possible to tune a variable PB unit to minimize the ITHD of this single motor. Using the ITHD sensing system with feedback control of the automatic breakers, the PB array can be disconnected if all the motors are shut down. Each PB array is configured to a particular motor load and maintaining proper matching of these balancing components is important for energy housekeeping for the multiple panel factories.

### DESCRIPTION OF PRIOR ART

Alternating current (AC) induction motors use a large proportion of generated electrical power. It is estimated that roughly 70% of the total power generated in the USA is used to power induction motors. To optimize power consumption, it is often desirable for a motor selected for a given application to be able to drive the largest possible load at the lowest possible line voltage. The relative efficiency of an AC motor may be expressed in terms of a power factor that is related a difference in phase between an AC voltage applied to the motor and an AC current demanded by the motor. The power factor is sometimes expressed as a cosine of the relative phase angle between the AC source voltage and the AC motor current. When the source voltage and motor current are in phase, the phase angle difference is equal to zero and the cosine of the phase angle is equal to 1. Correcting power factor in industrial systems by adding capacitors to match the inductive loads, matching impedance, has been improved over many years. The present invention flows from the detailed study of the effect of capacitors on the magnitudes and harmonics of the individual power phases.

In recent work, Emmet and Ray (3,4) 2002-4, have shown that production of amperage harmonics by an operating motor reduces the efficiency by trapping energy in non-sinusoidal waveforms that cannot be used for motor action. These harmonics are distributed throughout the local system causing over-heating and reducing the electrical efficiency of nearby loads. The earlier efficiency solutions which considered only power factor correction and not harmonic control are deficient in that they miss large opportunities for efficiency improvement. The present invention is a system for detecting and minimizing this wasteful harmonic power loss.

To more fully describe the prior motor efficiency art, several prior and existing methods will be discussed. In the prior art developed over the last 100 years, an AC induction motor, powered directly from the source, will run optimally (e.g., power factor close to 1) only in the situation where the AC motor has the largest possible load and the source powering the motor is operating at the lowest possible line voltage. As soon as the line voltage begins operating higher than the minimum possible voltage, or the mechanical load is lower than maximum possible load, the motor's power factor will be less than optimal.

An older way to optimize the power factor is to reduce the motor's supply voltage such that it is proportional to the instantaneous mechanical load of the AC induction motor. The earliest solution to this problem involved compensating a voltage lagging phase-dislocated current driving an AC induction motor with a leading current. This method could improve the power factor from the Utility's point of view, but at the same time this method caused large currents to exist between the motor and the service entrance capacitor bank used for compensation. Because of the high costs, low efficiency, and high maintenance of this procedure, this approach was never widely adopted.

Another solution to optimizing the power factor in AC induction motors was developed by Frank Nola, who developed a power factor control system for use with AC induction motors. Nola's power factor control system samples line voltage and current through the motor and decreases the power input to the motor in proportion to the detected phase displacement between the current and voltage (see for example U.S. Pat. Nos. 4,052,648, 4,433,276, and 4,459,528). This method reduces the power to the motor, as it becomes less loaded. Although Nola's power factor correction method was a big step forward, it had its basic problems. According to Nola's patents, the power of the motor is controlled by silicon-controlled rectifiers, which will turn on following a delay after the zero crossing of the input voltage. The motor's power reduction is proportional to the phase difference between the last zero crossing of the input voltage and the moment of turn on of the silicon controlled switch. For higher power factors, the system works reasonably well, but at lower power factors, the waveform of the motor amperage becomes severely distorted. The result is the emergence of harmonics on the input line frequency. Harmonics of a third order will cause power increase and heating of the neutral line, which is unacceptable due to the danger that it poses.

U.S. Pat. No. 5,105,327 granted to E. B. Wohlforth in 1992, for an AC Power Conditioning System is not considered prior art because both the drawings and claims held that the inductive magnetic chokes were the principal means of power conditioning. Later analysis by Emmet and Ray (3,4) has shown that the magnetic chokes were included to filter Radio Frequency (RF) interference only and had no effect on the 60 Hz power properties.

U.S. Pat. No. 6,194,881 to Parker et. al. discloses a switching power supply system that includes first and second AC switches which are operated at alternate intervals with respect to each other to permit current to flow between the AC power line source and the load over intervals of the AC voltage cycle. The system includes an energy storage element (e.g., an inductor) in an output filter that stores energy during intervals of the AC voltage cycle and releases the stored energy during the alternate intervals of the AC voltage cycle. Since the switches are turned on alternatively, the timing of the switches is critical to avoid current overlapping or open circuit. For example, if both switches are closed (i.e., “on”) there will be a short between the live and neutral lines. If the second switch opens before the first one closes an inductive ‘kick’ back voltage from the inductor could destroy both switches. Furthermore, the power loss is relative high since at any time there are four diodes and two switching elements in the current path. For these reasons this system has not been widely adapted.

U.S. Pat. No. 5,635,826 to Sugawara describes an AC power source system that is similar to the one disclosed by Parker in U.S. Pat. No. 6,194,881. In the Sugawara system, a first AC switch provided between input and output sides is on-off operated in a predetermined cycle. A second AC switch is provided on the output side of the first AC switch at a position to short-circuit the output side and on-off operated conversely to the first AC switch. A predetermined pause time is provided between the operations of the first and second AC switches. Each AC switch has two semiconductor elements, and diodes each connected between controlled terminals of and in opposite conduction polarity to each semiconductor element. Like polarity controlled terminals of the two semiconductor elements are connected to each other. The same control signal is supplied to control input terminals of each semiconductor element for on-off switching AC between the other controlled terminals of the semiconductor elements. Like the system described in U.S. Pat. No. 6,194,881, the Sugawara circuit uses alternating switching. Therefore the timing of the switching is critical to avoid current overlapping or open circuit. The Suguwara device uses passive dissipative components in a snubber circuit to limit surge currents. However, the passive dissipative components in the snubber circuit tend to limit the efficiency of this system.

### Functional Differences Between the Phase Balance Efficiency System and the Prior Art

The present invention, Phase Balance Efficiency System, is an improvement on prior art in at least three ways.

1) The PB Units included in the feedback circuit monitor and reduce the ITHD, amperage total harmonic distortion, produced by operating induction motors. In the lower harmonic orders, 3rd, 5th and 7th, the harmonic power is reduced by greater than 50%. By reducing these harmonics through voltage phase balancing and RCL harmonic filtering, the power trapped in these non-sinusoidal waveforms is released for additional motor action and the motor, being a constant horse power device, operates with lower kilowatt demand. Also, the dominant 5th harmonic is reverse sequence and thus is a magnetic brake to the motor. By reducing this reverse harmonic order, the motor efficiency is additionally increased.
2) The PB Arrays in the preferred embodiment are automatically tuned to sense the changing motor operation. When applied to every inductive panel they also match the inductive and capacitive reactance to improve the power factor throughout the entire system, not just at the service entrance. Because the PB Arrays are dedicated to each motor or inductive panel, they are local to the inductive loads. This proximity defining the capacitor-motor complex is necessary because motor harmonics dissipate with increasing distance and must be detected and filtered locally.
3) Many of the power disturbances affecting motor action are short-term transients. By attenuating these most frequent imbalance events, the PB unit reduces the associated electrical damage and the required maintenance.

Earlier methods of controlling the power factor involved large capacitor banks at the service entrance which were controlled using power factor sensors. Because of the large surging currents between these banks and large induction motors, RCL resonance caused by varying harmonics has occasionally burned out these large motors and intermediate components. In the PB Efficiency System the distributed motor control of the PB arrays prevents this damaging RCL resonance while minimizing the amperage heating in all low voltage conductors within the plant. All systems run cooler and more efficiently with the PB units. Component lifetime is extended, system dependability is greatly increased and maintenance and operating costs are reduced.

In 1998, at the Sykesville Northrop Grumman Radar Test Facility, a Delta PB array or Δ PB unit was connected in parallel to a 150 HP, 480 volt induction motor. The PB unit effect or the power saving mechanism were not understood at that time. A Dranetz Power Meter tested the single phase power and harmonic parameters ON/OFF to determine the effect of the PB unit effect on motor operation. All test data and phasor diagrams are given at four motor power levels in the Cutler-Hammer Report, “Power Measurements for the Northrop Grumman Radar Test Facility” 1999, (5).

These C-H data show that the PB Array causes the single-phase voltage and amperage amplitude maxima to become closer to the mean values over the 3 phases, which is termed phase balancing or PB. This PB is correlated with a 50% drop in Total Harmonic Amperage Distortion, ITHD, and a 10% drop in Kilowatt Demand, KW. These data were presented to the IEEE Industrial Power Power Conference in Pittsburgh in 2002 (3) and rejected because these unusual effects were new to the art and because the mechanisms were not understood by the authors.

These data were studied for three years and discussed in “Controlling Harmonics in the Polyphase Induction Motor” Emmet and Ray (4) 2002. Because the C-H Data were not accepted by the moderator or the members of the IEEE Industrial Power Conference, the conclusions of that presentation encouraged no comment or further work. The attempts to explain this unexpectedly large real power savings lay fallow for 15 years except for the personal work of R. T. Emmet which is being disclosed for the first time in this patent application.

The physical mechanism of Phase Balance is a linkage through the capacitor array electrical fields. The oscillating electric fields in the PB Array of capacitors connected across the phases, although not sinusoidal, are harmonic. These fields of 60 Hz alternating voltage polarity, A-C, B-C and C-A, cycle through each array capacitor sequentially. Because of the electronic stretching and rotation of polar molecules in the dielectric, the resultant charge in the capacitor dielectric, lags behind the oscillating electric field. This lag exists because the van der Waals molecular movement within the cyclically polarizing dielectric is slower than the electric field oscillation which drives the process. This lag within the dielectric provides a structural short-term memory of the previous phase and is the electrical mechanism making the amperage and voltage phase signals more similar in the vicinity of the capacitor array, which is defined as Van der Waals Phase Balancing. The short-term memory is the residual electrical structure in the polarizing dielectric remaining from the previous cycle. This balances the electrical properties of the phases without direct electrical connection and restores the phase balance at the user voltage. This lag is caused by dielectric adsorption as discussed by Williams {7}.

Now that the physical mechanism of Phase Balancing has been discussed, we can proceed to the mechanism for amperage harmonics ITHD reduction which was also detected in the C-H Data (5) and presented graphically in the above paper, “Control of Harmonics in Induction Motors”, Emmet and Ray 2002 (4). As shown in FIG. 4, when the PB unit is connected locally to the 3-phase induction motor, there is an interaction between the PB Array capacitors and the motor field coils which would form three rectangular RCL tank circuits. When the PB array or PB unit is placed in parallel with a 3-phase induction motor the capacitors interact with the field coils of the motor to form 3 rectangular resonating tank circuits, as shown in FIG. 4. These interactions further increase the dynamic resonance stability and selectively retain the lower harmonics orders, 3^{rd}, 5^{th} and 7^{th}, generated by the induction motor field coils. If these harmonics were not retained by the RCL filters, they would radiate into the distribution system as interference and be dissipated as heat. If these harmonics are dissipated they would need to be regenerated by the motor. Because they are retained, they don't require regeneration and the RCL filter reduces the power required by the operating motor. The net result is that this harmonic retention instantly releases the KW power for motor action and increases the motor efficiency by more than 5%.

The relative magnitudes of the capacitors and inductors in FIG. 4 are different for each application. The capacitance should be adjusted to provide for low-pass filter resonance that retains the 3rd, 5th and 7th harmonics while allowing the 60 HZ signal to pass. If the harmonic energy is retained in the motor-capacitor circuit, it will not pass into the distribution system as interference to be dissipated as heat. If the harmonics, which are necessary for motor action, are not dissipated, then they will not require regeneration which accounts for 3-5% increase in induction motor efficiency. SPICE Modeling has shown that the harmonic filter cells of FIG. 4 predict and replicate the data patterns shown in the Cutler-Hammer Data (5).

The capacitor array in the Phase Balance Efficiency System can be tuned to retain the amperage harmonics of any inductive panel, thus increasing the efficiency of the motors supplied from that panel. The exact mechanism of this RCL low-pass filter phenomenon remains for future study; however, we have found that the PB arrays could be tuned by varying the capacitance to dramatically increase the efficiency of any induction motor. The Phase Balance from the PB array has reduced voltage and amperage imbalance thus attenuating damaging transients. Tuning the RCL filtering tank cells to retain amperage harmonics has reduced the 3rd, 5th and 7th amperage harmonic energy by ca. 50%. The 5th harmonic mode is reverse sequence and acts as a motor brake. This harmonics reduction corresponds in the Cutler Hammer Data 1999 (5) to a 10% motor efficiency increase. The harmonic energy released is instantly available for motor action. Finer tuning of the variable PB Unit to further optimize motor efficiency remains for future work.

### Structural Differences Between Phase Balance Efficiency System and the Prior Art

The Phase Balance (PB) Efficiency System is unique in that it is structurally different from other known devices or solutions. More specifically, the present invention is unique due to the presence of: (1) a feedback loop controlling Amperage Total Harmonic Distortion, ITHD, which has been identified as a major factor decreasing the efficiency of three phase induction motors; (2) the PB Unit controls the power factor of the system by the same controlling feedback ITHD-sensing system; and (3) the PB Unit is a distributed power factor improvement system, as well as, a system for minimizing the production of system degrading and power wasting amperage harmonics. Furthermore, the process associated with the present invention is likewise unique and different from known processes and solutions. More specifically, the present invention process owes its uniqueness to the fact that it: (1) monitors and minimizes amperage ITHD harmonics which are produced by the induction motors; and 2) the system is unique because it also improves power factor locally without requiring the customary service entrance capacitor bank which give rise to damaging RCL resonance and miss opportunities to save power in the low voltage power distribution conductors throughout the multi-panel factory.

### Further Features of the Phase Balance Efficiency System

The Phase Balance (PB) Efficiency System and particularly the modular PB unit is unique in that said phase balance (PB) and Power Factor (PF) control system is waterproof and drop-proof thus allowing installation in wet and impact-prone industrial environments. Units have been considered for installation on oil pumping equipment in the remote Amazon Jungle and deep within mines subject to explosive impact. PB units have been submerged in the Chesapeake Bay water for 30 days without compromise of electrical properties. The PB unit is an extremely robust equipment skillfully constructed with robust components which require no service. The estimated lifetime of the PB unit is 100,000 hours. Furthermore, the PB unit is a self-healing surge protector and phase balancer with no metal oxide varistors (MOVs) or indicator bulbs that occasionally need replacement. The PB unit should outlast all other associated equipment. Dielectric adsorption, which supports electrical hysteresis in capacitors, is the mechanism of van der Waals phase balancing which is discussed by Tim Williams (7).

PATENT REFERENCES

| NUMBER | TITLE | DATE | ASSIGNMENT |
|---|---|---|---|
| U.S. Pat. No. | Electrical Transmis- | May 1, | George Westinghouse |
| 382,280 | sion of Power | 1888 | Manufacturing |
| | | | Company |
| U.S. Pat. No. | Power Factor | Jul. 19, | USA |
| 4,052,648A | Control System for | 1976 | |
| | AC Induction Motor | | |
| U.S. Pat. No. | Power Factor Control | Oct. 4, | USA |
| 4,052,648 | System for AC Motors | 1977 | |
| U.S. Pat. No. | 3-Phase Power Factor | Feb. 21, | USA |
| 4,433,276 | Controller | 1984 | |
| U.S. Pat. No. | Phase Detector for | Jul. 10, | USA |
| 4,459,528 | 3-phase Power | 1984 | |
| | Factor Controller | | |
| U.S. Pat. No. | AC Power | Apr. 14, | USES Manufacturing |
| 5,105,327 | Conditioning System | 1992 | Co. Inc. |
| U.S. Pat. No. | Input Waveform | Jun. 3, | Chiyoda Corporation |
| 5,635,826 | Follow up AC | 1997 | |
| | Power Source System | | |
| U.S. Pat. No. | Switching Power | Feb. 27, | NUMB (USA) Inc. |
| 6,194,881 | Supply for Lower | 2001 | |
| | Distribution | | |
| | System Disturbance | | |

### NON-PATENT REFERENCES

1. N. Tesla, “Electrical Transmission of Power”, U.S. Pat. No. 382,280, May 1, 1888.
2. C. P. Steinmetz, “The Alternating Current Induction Motor”, A.I.E.E. Trans., Vol. 14, 185-217, 1897.
3. R. T. Emmet and M. L. Ray, “AC Magnetic Phase Balancing, A Method of Power Quality Control”, IEEE/IAS Annual Conference, Pittsburgh, Pa., October, 2002.
4. R. T. Emmet and M. L. Ray. “Control of Harmonics in the Polyphase Induction Motor”, Power System World 2002, Navy Pier, Chicago, II, October, 2004.
5. A. W. Baum, “Power Measurements for Northrop Grumman Radar Test Facility, Chiller 2A, Sykesville, Maryland”, Cutler-Hammer Engineering Services & Systems, G.O. #ELY000502, 84 pp, May 11, 1999.
6. R. Burt, G. Birkett and X. S. Zhao, “A Review of Molecular Modeling of Electric Double Layer Capacitors”, Phys. Chem. Chem. Phys., 2014, 16, 6519-6538
7. T. Williams, “The Circuit Designer's Companion”, Oxford Univ Press 1991 Butterworth-Heinemann. Reprinted 1994. Pages 74-90.

What is claimed is:

1. In a polyphase AC power distribution network, subject to static and/or transient voltage imbalance and exhibiting Van der Vaal Phase Balancing, we claim a passive method of use for the purpose of restoring phase balance in an AC power distribution network at the user voltages comprising:
a) amperage, voltage or other measured supply parameters associated with the power distribution network;
b) amperage, voltage or other measured load parameters associated with the power distribution network; and
c) a balanced, symmetrical capacitor array connected across the phases of said AC network to reduce the phase imbalance therein and to restore phase balance with respect to the magnitudes of the single-phase amperage and voltage signals.

2. Said passive method of claim 1, in particular, comprising a symmetrical, balanced capacitor array connected across the phases in said AC network to balance the impedance of the inductive load therein, and, by varying the magnitude of said capacitor array using feedback loops sensing the total amperage harmonic distortion or other related power quality parameter on the supply side of the array connection point, to balance the magnitudes of the voltage and/or the amperage signals in the several phases and to minimize the total amperage harmonic distortion within said network, thereby reducing the power demand of the inductive loads therein and improving the network power quality by attenuating the spikes and surges and lowering the operating temperatures of the loads within the said AC distribution network.

3. The method of claim 1, wherein said one or more power consumption parameters comprises a parameter related to aggregate per phase power consumption.

4. The method of claim 1, wherein said one or more power consumption parameters comprises a parameter corresponding to each individual device associated with the said power distribution network.

5. The method of claim 1, wherein said one or more power supply parameters comprises voltage.

6. The method of claim 1, wherein said one or more power supply parameters comprises current.

7. The method of claim 1, wherein said one or more power supply parameters comprises a parameter related to aggregate per phase power supply.

8. The method of claim 1, wherein said one or more power supply parameters comprises a parameter corresponding to a storage component associated with the said power distribution network.

9. The method of claim 1, wherein said one or more power supply parameters comprises a parameter corresponding to total amperage harmonic distortion associated with the said distribution network.

10. In a polyphase AC power distribution system, subject to cogeneration of harmonic waveforms from one or more operating induction motors and exhibiting RCL harmonic filtering of said waveforms, we claim a passive method of use for the purpose of retaining the harmonic power in the vicinity of said motor and not allowing it to dissipate as interference and heat into the said distribution system at the user voltages comprising:
a) amperage, voltage or other measured supply parameters associated with the power distribution network;
b) amperage, voltage or other measured load parameters associated with the power distribution network; and
c) a balanced, symmetrical capacitor array connected across the phases of said AC distribution network to retain harmonic energy produced by said induction motor in the vicinity of the motor and not allow it to dissipate as heat and interference in the said supporting distribution system.

11. Said passive method of claim 10, in particular, comprising the use of a symmetrical, balanced capacitor array connected across the phases in said AC network to balance the impedance of the inductive load therein, and, by varying the magnitude of said capacitor array using feedback loops sensing the total amperage harmonic distortion or other related power quality parameter on the supply side of the array connection point, to balance the magnitudes of the voltage and/or the amperage signals in the several phases and to minimize the total amperage harmonic distortion within said network, thereby reducing the power demand of the inductive loads therein and improving the network power quality by attenuating the spikes and surges and by lowering the operating temperatures of the loads within the said AC distribution network.

12. The method of claim 10, wherein said one or more power consumption parameters comprises a parameter related to aggregate per phase power consumption.

13. The method of claim 10, wherein said one or more power consumption parameters comprises a parameter corresponding to each individual device associated with the said power distribution network.

14. The method of claim 10, wherein said one or more power supply parameters comprises voltage.

15. The method of claim 10, wherein said one or more power supply parameters comprises current.

16. The method of claim 10, wherein said one or more power supply parameters comprises a parameter related to aggregate per phase power supply.

17. The method of claim 10, wherein said one or more power supply parameters comprises a parameter corresponding to a storage component associated with the said power distribution network.

18. The method of claim 10, wherein said one or more power supply parameters comprises a parameter corresponding to total amperage harmonic distortion associated with the said distribution network.
